(19) United States
(12) Patent Application Publication
(10) Pub. No.: US 2018/0036996 A1
(43) Pub. Date: Feb. 8, 2018

(54) METHODS OF COMBINING A FIBER MAT AND A FABRIC VEIL TO MAKE A SEAMLESS FIBER REINFORCED PLASTIC PART

(71) Applicant: Cerex Advanced Fabrics, Inc., Cantonment, FL (US)

(72) Inventors: Albert E. Ortega, Pensacola, FL (US); Daniel Patrick Baillie, Pensacola, FL (US)

(21) Appl. No.: 15/668,081

(22) Filed: Aug. 3, 2017

Related U.S. Application Data
(60) Provisional application No. 62/370,545, filed on Aug. 3, 2016.

(51) Int. Cl. B32B 5/02; D02G 3/18; D04H 3/12; D04H 3/10; B32B 7/12; B32B 37/12

(52) U.S. Cl. CPC B32B 5/022; B32B 7/12; B32B 37/12; D04H 3/12; D04H 3/10; D02G 3/18; B32B 2471/04

(57) ABSTRACT

Methods of combining a reinforced fiber and a veil using an adhesive, for use in making seamless fiber reinforced plastic parts, are provided. The combined mat and veil can be used to make seamless reinforced fiber plastic parts, thereby eliminating the cost and the need for any further downstream processing to cover an unsightly stitched or sewn seam.

### CROSS-REFERENCE TO RELATED APPLICATION

This application claims the benefit of U.S. Provisional Application Ser. No. 62/370,545, filed Aug. 3, 2016, the disclosure of which is hereby incorporated by reference in its entirety, including any figures, tables, and drawings.

### FIELD OF THE INVENTION

Embodiments of the subject invention relate to methods used to combine a mat (e.g., a glass or carbon mat) to a fabric veil to make seamless fiber reinforced plastic parts. If adhesives are used to combine the mat to the veil, they must withstand the high pressures and temperatures along with the resin environment used in the process to make the part. Parts made with this fiber mat-veil combination will be seamless adding to the aesthetic beauty of the part. No painting of this fiber reinforced plastic part is required to cover an undesirable, unsightly stitched or sewn seam providing a lower cost to produce the parts.

### BACKGROUND

Various methods are used to make fiber reinforced plastics. Pultrusion is a continuous process of manufacturing fiber reinforced parts with constant cross-section whereby reinforced fibers are pulled through a resin, possibly followed by a separate preforming system used to manipulate the combination of veil, reinforcement and resin in order to reduce die wear and ensure uniformity, and into a heated die, where the resin undergoes polymerization or curing. Fiber reinforcements such as rovings, mats, woven products and others made of fiberglass, carbon, aramid and other materials are saturated or wet out in uncured thermoset resin. Surfacing veils are commonly used to provide uniform distribution of the resin, protect the metal die from abrasion by the reinforcing materials like fiberglass or carbon and enhance the final appearance of the fiber reinforced plastic part. These saturated materials are then pulled through a heated metal die. The resin transforms from a liquid to a solid in the die. This is known as curing. In some cases, fiber reinforcement mats are stitched or sewn to the surfacing veil to prevent movement of these two layers when they pass through the die. Pull speed, die temperature, catalysts and cure promoters are all variables that are used to control the cure rate as the product forms in the die. Many resin types are used in pultrusion including polyester, polyurethane, vinyl ester, phenolic and epoxy. A. M. Fairuz et al published an article in the American Journal of Applied Sciences titled “Polymer Composite Manufacturing using a pultrusion process: a review” that is a general discussion of the pultrusion process. This article is incorporated by reference. The Pultex Pultrusion Design Manual by Creative Pultrusion describes the design options available for engineers to use for creating fiberglass reinforced plastic parts. This manual is incorporated in its entirety by reference.

An excellent discussion of the pultrusion process using an epoxy resin can be found in a report titled “Pultrusion Process Characterization” funded under NASA Contract NAS8-37193 by James G. Vaughan and Robert M. Hackett of the School of Engineering at the University of Mississippi. This report is incorporated in its entirety by reference. Polyester resin with pigments and additives are commonly used to make parts in the pultrusion process. Polyurethane, epoxy and other resins are also used. Pull rates can vary depending on the desired property, quality and cost of the final parts. Zone temperatures typically run about 275 to 325° F. and slightly higher for polyurethane at about 300 to 375° F. Processes with epoxy resins can run even higher, up to about 400° F.

The technology is not limited to thermosetting resins. Thermoplastic matrices such as polybutylene terephthalate either by powder impregnation of the glass fiber or by surrounding it with sheet material of the thermoplastic matrix that is then molten up are also successfully used in the pultrusion process.

Reinforcement materials selected will depend on the desired properties of the part being produced. The reinforcement material is pulled through the die under tension. It is critical that a uniform distribution of reinforcement in the resin is achieved to ensure that the finished product does not have any areas of structural weakness. It is also important that the reinforcement material be saturated or wet out with the resin. U.S. Pat. No. 3,960,629 to Goldsworthy describes a pultrusion process and U.S. Pat. No. 4,935,279 to Perko describes a pultrusion process used to make signs. Both of these patents are hereby incorporated herein by reference.

Any other process that uses layers of fiber reinforcement such as but not limited to fiberglass and veil that are sewn or stitched together will benefit from this invention. For example, compression molding, contact molding or open molding, resin transfer molding and structural reaction injection molding, vacuum resin transfer molding or any other process used to make reinforced fiber plastic parts that uses sewn or stitched layers of fiber mat and veils would enjoy the benefit of practicing this invention.

### BRIEF SUMMARY

Embodiments of the subject invention provide methods of combining a fiber mat to a veil to make seamless fiber reinforced plastic parts. In an embodiment, a veil and a fiber mat can be combined using an adhesive to bond the two layers together. The adhesive can be selected to withstand high pressures, high temperatures, and exposure to resins used to make the reinforced fiber plastic parts and still maintain the stability of the layers. The combination of the veil and the fiber mat can then be used to make seamless reinforced fiber plastic parts, thereby eliminating the cost and the need for any further downstream processing such as painting to cover the unsightly stitched or sewn seam.

### DETAILED DESCRIPTION

In the following detailed description of the subject invention and its preferred embodiments, specific terms are used in describing the invention; however, these are used in a descriptive sense only and not for the purpose of limitation. It will be apparent to the skilled artisan having the benefit of the instant disclosure that the invention is susceptible to numerous variations and modifications within its spirit and scope. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

Reinforcing fiber mats such as fiberglass mats and roving are commonly used as a layer in reinforced fiber plastic parts. Reinforcing fiber mats are often stitched or sewn to veils so that both layers can be fed into pultrusion dies or molds with little to no movement in the transverse direction for the pultrusion process and any direction in the mold process. Unfortunately, the stitches will be visible in the final part and in some cases appear as an aesthetic defect. These parts are frequently painted to remove this undesirable aesthetic feature adding cost to fabricate the parts. Stitching or sewing also introduces small holes into the veil and the fiberglass mat that can compromise the flow characteristics of both layers. It would be advantageous to combine the fiberglass mat layer with the veil by using another method that does not require a stitched or sewn seam eliminating the cost and the need for further downstream processing such as painting to hide the aesthetic defect. It would also be advantageous to have a seamless fiber reinforced plastic part.

In a particular embodiment, a reinforcing fiberglass mat that has a basis weight of about 9.0 ounces per square yards (osy) as measured by ASTM test method D3776, thickness of about 0.0466 inches as measured using ASTM D1777, glass filaments of about 21 microns in diameter and an air permeability of about 561 ft3/min/ft2 as measured by ASTM D737 can be adhered to a veil. In yet another embodiment, an aramid fiber mat can be used. The invention is not limited to glass, aramid or carbon fiber mats. Other fibers can also be used. The mat can be either a nonwoven or a woven mat. The mat can have a basis weight as measured by ASTM D3776 of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in ounces per square yard (osy)): 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5, 5.5, 6, 6.5, 7, 7.5, 8, 8.5, 9, 9.5, 10, 11, 12, 13, 14, 15, 16, 17, 18, 19, 20, 25, 30, 35, 40, 45, 50, 55, 60, 65, 70, 75, 80, 85, 90, 95 or 100. For example, a mat can have a basis weight of about 0.85 osy, about 1 osy, about 2 osy, about 4 osy, about 6 osy, about 9 osy, about 15 osy. In particular embodiments, a mat can have a basis weight of no more than about 3 osy, no more than about 6 osy, no more than about 8 osy, or no more than about 9 osy. In other embodiments, a mat can have a basis weight of at least about 3 osy, at least about 6 osy, at least about 8 osy, or at least about 9 osy. The mat can have a thickness as measured by ASTM D1777, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in inches): 0.004, 0.005, 0.010, 0.015, 0.030, 0.025, 0.030, 0.035, 0.040, 0.045, 0.0466, 0.050, 0.060, 0.070, 0.080, 0.090, 0.10, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.4, 1.5, 1.6, 1.7, 1.8, 1.9, 2.0, 2.1, 2.2, 2.3, 2.4, 2.5, 2.6, 2.7, 2.8, 2.9, or more than 3.0. For example, a mat can have a thickness of about 0.025 inches, about 0.0466 inches, about 0.070 inches, about 0.300 inches or about 0.400 inches, or more than about 0.401 inches. In particular, embodiments a mat can have a thickness of at least about 0.004 inches, at least about 0.010 inches, at least about 0.025 inches, at least about 0.0466 inches, at least about 0.070 inches, at least about 0.100 inches, at least about 0.400 inches or at least about 0.600 inches. The mat can have an air permeability, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in ft3/min/ft2): 2000, 1900, 1800, 1700, 1650, 1600, 1550, 1500, 1450, 1400, 1380, 1360, 1350, 1300, 1250, 1200, 1160, 1150, 1140, 1100, 1000, 950, 900, 870, 850, 800, 750, 700, 690, 650, 600, 590, 580, 579, 570, 550, 525, 500, 475, 450, 425, 400, 375, 350, 325, 300, 275, 250, 225, 200, 175, 150, 125, 100, 75, 50, 25, 10, or 5. For example, a mat can have an air permeability of about 1300 ft3/min/ft2, about 1200 ft3/min/ft2, about 1100 ft3/min/ft2, about 1000 ft3/min/ft2, about 900 ft3/min/ft2, about 800 ft3/min/ft2, about 700 ft3/min/ft2, about 600 ft3/min/ft2, about 579 ft3/min/ft2, about 550 ft3/min/ft2, about 500 ft3/min/ft2, about 400 ft3/min/ft2, about 300 ft3/min/ft2, about 200 ft3/min/ft2, or about 100 ft3/min/ft2. In particular embodiments, a mat can have an air permeability of at least about 1300 ft3/min/ft2, at least about 1200 ft3/min/ft2, at least about 1100 ft3/min/ft2, at least about 1000 ft3/min/ft2, at least about 900 ft3/min/ft2, at least about 800 ft3/min/ft2, at least about 700 ft3/min/ft2, at least about 600 ft3/min/ft2, at least about 579 ft3/min/ft2, at least about 500 ft3/min/ft2, at least about 400 ft3/min/ft2, at least about 300 ft3/min/ft2, at least about 200 ft3/min/ft2, or at least about 50 ft3/min/ft2. In another embodiment, a carbon fiber mat can be used. The reinforcing fiber does not have to be in a mat. It can also be in the form of yarn or roving.

A variety of technologies known in the art can be used to make the veil of this invention. For example, the veil can be a woven fabric, a nonwoven fabric, a knit fabric, an apertured fabric, a hydroentagled fabric, a spunbond fabric, a carded fabric, a dry laid fabric, a needle punched fabric, a wet laid fabric or a fabric made using other techniques known to the current art. The veils can be made using polymers such as nylon, polyester, polybutylene terephthalate, polypropylene or a combination of these polymers or even glass. Colors can also be added to these fabrics if desired. The veils can also be made from filaments that comprise more than one polymer such as bicomponent or tricomponent filaments. The veils can be made with filaments that have round, oval, trilobal, multilobal, hollow or other cross sections. The veils can also be made with filaments that have a combination of these cross sections and more than one cross section. In a specific embodiment, veils can be made from fabric with a combination of filaments that have a round cross section and a trilobal cross section. In another embodiment, the veil can be selected from a variety of nylon or polyester spunbond fabrics. Hydroentangled polyester fabric can also be used as a veil.

An adhesive system must be chosen that can withstand the processing of the reinforcement fiber and veil into a part along with the exposure to the resin at the processing temperatures and pressures. The adhesive and the amount applied per area is also critical to the cost required to combine the veil and the reinforcing fiber and to the permeability of the combined layers. The level of adhesive must be chosen to allow the resin to flow without restriction. One familiar with the art will understand that there is a maximum amount of adhesive that can be used. Using a level of adhesive that is above this maximum amount will produce a defective part. The practitioner of the invention will desire to use the least amount of adhesive to combine the reinforcing fiber and the veil to keep the costs at a minimum and maintain as high an air permeability as possible to allow the resin to flow through the layers of reinforcing fiber and veil. A method of adhering the veil and the reinforcing fiber must also be chosen.

In a specific embodiment, a fabric can be used as a veil that has a basis weight of about 2.0 ounces per square yards (osy) as measured by ASTM test method D3776, thickness of about 0.0137 inches as measured using ASTM D1777, machine direction grab tensile strength of at least about 68 lbsf as measured using ASTM D5034, machine direction grab elongation of about 66% as measured using ASTM D5034, cross direction grab tensile strength of at least about 52 lbsf as measured using ASTM D5034, cross direction grab elongation of about 72% as measured using ASTM D5034, machine direction trapezoidal tear strength of at least about 17 lbsf as measured by ASTM D5587, cross direction trapezoidal tear strength of at least about 11 lbsf measured by ASTM D5587, a burst strength of at least about 58 pounds per square inch (PSI) as measured by ASTM D3786 and air permeability of about 249 ft3/min/ft2 as measured by ASTM D737. This fabric can be a nylon spunbond fabric. The nylon fabric is thermally bonded with a diamond pattern and can be of a natural color or colored. In a particular embodiment, TiO2 and an optical brightener are added to make a whiter fabric. These fabrics are sold under the trademarks Orion® and N-Fusion® and are available from Cerex Advanced Fabrics, Inc. in Cantonment, Fla. These fabrics can be made from other polymers such as but not limited to polyester or polybutylene terephthalate. These fabrics can be made from filaments that comprise more than one polymer such as bicomponent or tricomponent filaments. These fabrics can be made with filaments that have round, oval, trilobal, multilobal, hollow or other cross sections. In a specific embodiment, fabrics can be made with filaments that have a round cross section. These fabrics can also be made with filaments that have a combination of these cross sections and more than one cross section. In another specific embodiment, fabrics can be made with a combination of filaments that have a round cross section; a trilobal cross section or both round and trilobal cross sections.

The nylon fabrics of these embodiments can also be thermally bonded with the pattern illustrated in registered U.S. Pat. No. 2,163,116. These fabrics are sold under the trademarks PBN-II® and N-Fusion® and are available from Cerex Advanced Fabrics, Inc. These fabrics will not unravel when cut. Other patterns can be used. Examples of fabrics that can be used with another pattern is a herringbone patterned fabric sold under the trademarks SPECTRAIVIAX® and N-Fusion® available from Cerex Advanced Fabrics, Inc. Other polymers or combination of polymers can be used to make the fabric including but not limited to polyester and polypropylene. Dyes, pigments, optical brighteners or other materials that impart specific properties can be used.

In another embodiment, a fabric can be used as a veil that has a basis weight of about 1.0 ounce per square yards (osy) as measured by ASTM test method D3776, thickness of about 0.0089 inches as measured using ASTM D1777, machine direction grab tensile strength of at least about 28 lbsf as measured using ASTM D5034, machine direction grab elongation of about 58% as measured using ASTM D5034, cross direction grab tensile strength of at least about 20 lbsf as measured using ASTM D5034, cross direction grab elongation of about 64% as measured using ASTM D5034, machine direction trapezoidal tear strength of at least about 8 lbsf as measured by ASTM D5587, cross direction trapezoidal tear strength of at least about 5 lbsf as measured by ASTM D5587, a burst strength of at least about 25 PSI as measured by ASTM D3786 and air permeability of about 600 ft3/min/ft2 as measured by ASTM D737. In a particular embodiment, a nylon spunbond fabric is used. This nylon fabric is thermally bonded with a diamond pattern and can be of a natural color or colored. In a particular embodiment, TiO2 and an optical brightener is added to make a whiter fabric. These fabrics are sold under the trademarks Orion® and N-Fusion® and are available from Cerex Advanced Fabrics, Inc. These fabrics can be made from other polymers such as but not limited to polyester or polybutylene terephthalate. These fabrics can be made from filaments that comprise more than one polymer such as bicomponent or tricomponent filaments. These fabrics can be made with filaments that have round, oval, trilobal, multilobal, hollow or other cross sections. In a specific embodiment, fabrics can be made with filaments that have a round cross section. These fabrics can also be made with filaments that have a combination of these cross sections and more than one cross section. In another specific embodiment, fabrics can be made with a combination of filaments that have a round cross section; a trilobal cross section or both round and trilobal cross sections.

The nylon fabrics can be thermally bonded with the pattern illustrated in registered U.S. Pat. No. 2,163,116. These fabrics are sold under the trademarks PBN-II® and N-Fusion® and are available from Cerex Advanced Fabrics, Inc. These fabrics will not unravel when cut. Other patterns can be used. Examples of fabrics that can be used with another pattern is a herringbone patterned fabric sold under the trademarks SPECTRAIVIAX® and N-Fusion® available from Cerex Advanced Fabrics, Inc. Other polymers or combination of polymers can be used to make the fabric including but not limited to polyester and polypropylene. Dyes, pigments, optical brighteners or other materials that impart specific properties can be added in the extruder when making these fabrics.

Dyes or other materials that impart high visibility colors (e.g., yellow, orange and red) commonly include hazardous materials, for example, metals such as hexavalent chromium and/or lead. Only a few materials exist that can impart high visibility colors, do not contain these hazardous materials, and can tolerate the high temperatures required in processing polymer pellets into fabrics. In certain embodiments, a UV stabilizer (blocker) or an antioxidant such as sold under the trade names Cesa® Light 7725 and S-EED®, can be added in an extruder to make a nonwoven fabric with improved corrosion resistance or light resistance and improved color retention. Such dyes or additives do not contain hazardous materials, such as hexavalent chromium or lead. In a particular embodiment, a combination of a UV stabilizer (blocker) or an antioxidant or both, can be added in an extruder to make a nonwoven fabric that can include a solvent red dye and a solvent orange dye to make a nonwoven fabric with a high visibility color (a shade of orange) with improved corrosion resistance or light resistance and improved color retention. This fabric will pass the criteria for NSF/ANSI Standard 61-2007a (can be found at www.nsf.org), which is the nationally (in the United States) recognized health standard for all devices, components, and materials that contact drinking water. This fabric will also pass the criteria for SW-846, Third Edition, which is the EPA standard for allowing wastes to be treated as non-hazardous waste.

In yet another embodiment, a fabric can be used as a veil that has a basis weight of about 0.7 osy as measured by ASTM test method D3776, thickness of about 0.0045 inches as measured using ASTM D1777, machine direction grab tensile strength of at least about 23 lbsf as measured using ASTM D5034, machine direction grab elongation of about 48% as measured using ASTM D5034, cross direction grab tensile strength of at least about 14 lbsf as measured using ASTM D5034, cross direction grab elongation of about 57% as measured using ASTM D5034, machine direction trapezoidal tear strength of at least about 9 lbsf as measured by ASTM D5587, cross direction trapezoidal tear strength of at least about 6 lbsf as measured by ASTM D5587, a burst strength of at least about 23 PSI as measured by ASTM D3786 and air permeability of about 785 ft3/min/ft2 as measured by ASTM D737. The fabric is chemically bonded as described in U.S. Pat. No. 3,516,900 and U.S. Pat. No. 4,168,195. The surface of this fabric is smooth with no point bonds. This fabric is commercially available from Cerex Advanced Fabrics, Inc. in Cantonment, Fla. and is sold under the trademarks, CEREX® and N-FUSION®. This fabric will also pass the criteria for SW-846, Third Edition, which is the EPA standard for allowing wastes to be treated as non-hazardous waste.

In another embodiment, a fabric that has a basis weight of at least about 1.0 osy as measured by ASTM D3776 can be used as a veil. This fabric can have a thickness of at least about 0.010 inches as measured by ASTM D1777, machine direction grab tensile strength of at least about 23 lbsf as measured using ASTM D5034, machine direction grab elongation of about 25% as measured using ASTM D5034, cross direction grab tensile strength of at least about 15 lbsf as measured using ASTM D5034 and cross direction grab elongation of about 25% as measured using ASTM D5034. This fabric can be a hydroentangled polyester nonwoven fabric. In a specific embodiment, the hydroentangled polyester fabric can have a basis weight of at least about 1.1 osy as measured by ASTM D3776, a thickness of 0.011 inches as measured by ASTM D1777, machine direction grab tensile strength of at least about 23 lbsf as measured using ASTM D5034, machine direction grab elongation of about 25% as measured using ASTM D5034, cross direction grab tensile strength of at least about 15 lbsf as measured using ASTM D5034 and cross direction grab elongation of about 25% as measured using ASTM D5034. In another specific embodiment, the hydroentangled polyester fabric can have a basis weight of at least about 1.2 osy as measured by ASTM D3776, a thickness of at least about 0.010 inches as measured by ASTM D1777, machine direction grab tensile strength of at least about 23 lbsf as measured using ASTM D5034, machine direction grab elongation of about 25% as measured using ASTM D5034, cross direction grab tensile strength of at least about 15 lbsf as measured using ASTM D5034 and cross direction grab elongation of about 25% as measured using ASTM D5034. In yet another specific embodiment, the hydroentangled polyester fabric can have a basis weight of 1.6 osy as measured by ASTM D3776, a thickness of 0.014 inches as measured by ASTM D1777, machine direction grab tensile strength of at least about 45 lbsf as measured using ASTM D5034, machine direction grab elongation of about 25% as measured using ASTM D5034, cross direction grab tensile strength of at least about 28 lbsf as measured using ASTM D5034 and cross direction grab elongation of about 25% as measured using ASTM D5034. These polyester hydroentangled fabrics can also be apertured to increase the porosity.

In another embodiment, a fabric can be used as a veil that has a basis weight of about 0.85 osy as measured by ASTM test method D3776, thickness of about 0.005 inches as measured using ASTM D1777, machine direction grab tensile strength of at least about 30 lbsf as measured using ASTM D5034, machine direction grab elongation of about 48% as measured using ASTM D5034, cross direction grab tensile strength of at least about 18 lbsf as measured using ASTM D5034, cross direction grab elongation of about 58% as measured using ASTM D5034, machine direction trapezoidal tear strength of at least about 10 lbsf as measured by ASTM D5587, cross direction trapezoidal tear strength of at least about 7 lbsf as measured by ASTM D5587, a burst strength of at least about 28 PSI as measured by ASTM D3786 and air permeability of about 625 ft3/min/ft2 as measured by ASTM D737. The fabric is chemically bonded as described in U.S. Pat. No. 3,516,900 and U.S. Pat. No. 4,168,195. The surface of this fabric is smooth with no bond point. This fabric is commercially available from Cerex Advanced Fabrics, Inc. in Cantonment, Fla. and is sold under the trademarks, CEREX® and N-FUSION®. This fabric will also pass the criteria for SW-846, Third Edition, which is the EPA standard for allowing wastes to be treated as non-hazardous waste.

In yet another embodiment, the veil fabric can be a polyester spunbond with a basis weight of at least about 1.0 osy as measured by ASTM test method D3776, thickness of about 0.008 inches as measured using ASTM D1777, machine direction grab tensile strength of at least about 16 lbsf as measured using ASTM D5034, machine direction grab elongation of about 36% as measured using ASTM D5034, cross direction grab tensile strength of at least about 14 lbsf as measured using ASTM D5034 and cross direction grab elongation of about 48% as measured using ASTM D5034. In still another embodiment, the veil fabric can be a polyester spunbond with a basis weight of at least about 1.2 osy as measured by ASTM test method D3776, thickness of about 0.009 inches as measured using ASTM D1777, machine direction grab tensile strength of at least about 21 lbsf as measured using ASTM D5034, machine direction grab elongation of about 47% as measured using ASTM D5034, cross direction grab tensile strength of at least about 14 lbsf as measured using ASTM D5034 and cross direction grab elongation of about 48% as measured using ASTM D5034.

A fabric used as a veil can have a basis weight as measured by ASTM D3776 of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in ounces per square yard (osy)): 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5, 5.5, 6, 6.5, 7, 7.5, 8, 8.5, 9, 9.5, 10, 11, 12, 13, 14, 15, 16, 17, 18, 19, 20, 25, 30, 35, 40, 45, 50 or more than 50. For example, a fabric used as a veil can have a basis weight of about 0.4 osy, about 0.5 osy, about 0.6 osy, about 0.7 osy, about 0.75 osy, about 0.8 osy, about 0.85 osy, about 0.9 osy, about 1 osy, about 1.1 osy, about 1.6 osy, about 2 osy, about 3 osy, or about 4 osy. In particular embodiments, a fabric used as a veil can have a basis weight of no more than about 4 osy, no more than about 2 osy, no more than about 1 osy, no more than about 0.85 osy, no more than about 0.75 osy, no more than about 0.7 osy, no more than about 0.6 osy or no more than about 0.4 osy. In other embodiments, a fabric can have a basis weight of at least about 2 osy, at least about 1.6 osy, at least about 1.1 osy, at least about 1 osy, at least about 0.85 osy at least about 0.7 osy, at least about 0.6 osy, or at least about 0.45 osy.

The fabric used as a veil can have a thickness as measured by ASTM D1777, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in inches): 0.001, 0.002, 0.003, 0.004, 0.0045, 0.005, 0.006, 0.007, 0.008, 0.0089, 0.009, 0.010, 0.011, 0.012, 0.013, 0.0137, 0.014, 0.015, 0.016, 0.017, 0.018, 0.019, 0.020, 0.022, 0.024, 0.026, 0.028, 0.030, 0.035, 0.030, 0.035, 0.040, 0.045, 0.0466, 0.050, 0.060, 0.070, 0.080, 0.090, 0.10, 0.15, 0.2, 0.25, 0.3, 0.35, 0.4, 0.45, 0.5, 0.55, 0.6, 0.65, 0.7, 0.75, 0.8, 0.85, 0.9, 0.95, 1, or more than 1.0. For example, a fabric used as a veil can have a thickness of about 0.003, about 0.0045 inches, about 0.008 inches, about 0.0089 inches, about 0.009 inches, about 0.010 inches, about 0.011 inches, about 0.0137 inches, about 0.014 inches, about 0.2 inches, about 0.400 inches, or more than about 0.401 inches. In particular, embodiments a fabric used as a veil can have a thickness of at least about 0.003 inches, at least about 0.0045 inches, at least about 0.050 inches, at least about 0.008 inches, at least about 0.0089 inches, at least about 0.009 inches, at least about 0.010 inches, at least about 0.011 inches, at least about 0.0137 inches, at least about 0.014 inches, inches, at least about 0.100 inches, at least about 0.400 inches or at least about 0.600 inches.

The fabric used as a veil can have an air permeability as measured by ASTM D737, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in ft3/min/ft2): 5, 10, 25, 50, 100, 125, 150, 160, 200, 249, 300, 350, 407, 450. 500, 550, 591, 600, 625, 650, 675, 700, 750, 785, 800, 850, 869, 870, 900, 950, 1000, 1050, 1100, 1140, 1150, 1156, 1200, 1250, 1300, 1350, 1359, 1380, 1381, 1386, 1400, 1450, 1500, 1550, 1600, 1650, 1653, 1700, 1750, 1800, 1850, 1900, 1950, 1974, 2000, 3000, or more than 3000. For example, a fabric used as a veil can have an air permeability of about 125 ft3/min/ft2, of about 249 ft3/min/ft2, of about 600 ft3/min/ft2, of about 625 ft3/min/ft2, of about 785 ft3/min/ft2, or more than about 786 ft3/min/ft2. In particular embodiments, a fabric used as a veil can have an air permeability of at least about 125 ft3/min/ft2, of at least about 160 ft3/min/ft2, of at least about 249 ft3/min/ft2, of at least about 600 ft3/min/ft2, of at least about 625 ft3/min/ft2, of at least about 785 ft3/min/ft2, or at least about 786 or more ft3/min/ft2.

In one embodiment, fiberized adhesive spray of hot melt adhesive can be applied to either the mat or the veil or both using rotary spray heads. This hot melt application system is available commercially from ITW Dynatec located in Hendersonville, Tenn. The application of the hot melt adhesive can be conducted in a manufacturing line separate from the production line making the fiber reinforced plastic part. In another embodiment, dots of adhesive can be applied to a veil using a gravure printing system. This method of adhesive application is well known in the art. The veil with the dots of adhesive can then be heated and adhered to a fiber reinforcing mat or fiber reinforcing roving prior to entering a die. This will prevent movement of the two layers preventing the creation of defective parts.

The fiber mat and veil combination can then be used in manufacturing processes making the fiber reinforced part. Alternatively, the application of the hot melt adhesive can be installed in the manufacturing line that is making the fiber reinforced plastic part. This alternative embodiment requires an adhesive application in every manufacturing line making the fiber reinforced plastic part.

Selection of the adhesive depends on the method used to make the fiber reinforced plastic part. The adhesive must be selected to be able to withstand the temperatures and pressures that the specific process uses. The adhesive must also be able to withstand exposure to the resin and any additives used in the resin system. The adhesive must also be selected so as not to adversely affect the permeability of the combined fiber mat and veil. The permeability of the combined layers must be sufficiently high enough to allow resin to pass through them when processing the layers into a fiber reinforced plastic part. Optimization studies will typically have to be conducted to find the best adhesive that is compatible with the resin system and meets the process design parameters such as process speed, costs and part properties. One skilled in the art understands that the maximum amount of adhesive that can be used will be limited by the ability of resin to flow through the layers of veil and the reinforcement fiber or mat. This amount will also be the most costly case regarding adhesive use. The lowest cost case regarding the use of adhesive will be the case where the veil and reinforcing fiber are adhered together and maintain their adherence through the resin wetting and curing steps.

The adhesive can be applied in the form of a nonwoven web, a net, random nanofibers, a nanofiber web, dots, lines, streams, fibrillated lines or streams, spray, fiberized spray, spray mist, electrospun nanofibers or any other means known in the art. The adhesive can be made of any material that will stick or combine the mat and veil such as but not limited to polyvinyl acetate, ethylene vinyl acetate, polyamides, copolyamides, polyesters, copolyesters, polyolefins, acrylics, binder materials known in the art, copolymers of these, mixtures of these, blends of these or any combination of these. Any material that provides adhesion will work as long as the mat and veil stick together through the die or mold until the resin that is used to make the seamless fiber reinforced part cures or becomes solid without creating a defect.

The adhesive can be applied at a level of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in ounces per square yard (osy)): less than 0.01, 0.01, 0.05. 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5, 5.5, 6, 6.5, 7, 7.5, 8, 8.5, 9, 9.5, 10 or more.

The adhesive can have a melt point, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in degrees Centigrade):less than 35, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 266 or higher.

The adhesive can have a Melt Volume-Flow Rate viscosity of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though, embodiments are not limited thereto (all numerical values are in cubic centimeters per 10 minutes): less than 1, 1, 2, 3, 4, 5, 6, 7, 8, 9, 10, 11, 12, 13, 14, 15, 16, 17, 18, 19, 20, 22, 24, 26, 28, 30, 32, 33, 34, 36,40,44,48,52,56, 60, 64, 68, 70, 74, 76, 78, 80, 84, 86, 88, 90, 94, 98, 100, 102, 103 or higher.

In an embodiment, a low density polyolefin adhesive web available as product, style 3B8D16, from Protechnic in Cerney, France was used to adhere a 9.0 osy fiberglass mat previously described to a 2.0 osy nylon spunbond fabric (veil) previously described. In another embodiment, the 2.0 osy nylon spunbond fabric is replaced with a 1.0 osy nylon spunbond fabric previously described. The polyolefin web has a basis weight of about 0.42 osy, a thickness of about 0.006 inches, a softening point of about 100° F. and a melting range of about 100 to 115° C. The viscosity of the polymer that this web is made from is higher than about 101 cubic centimeters per 10 minutes. This veil and glass mat combination can now be used as a single layer in a pultrusion process entering into a resin bath prior to entering into the die. In some embodiments, it may be preferable to prewet the veil and mat combination with resin prior to exposing it to the resin dip bath prior to the die.

In another embodiment, a copolyamide adhesive web available as product, style 1G8, from Protechnic in Cerney, France can also be used to adhere a 9.0 osy fiberglass mat previously described to a 2.0 osy nylon spunbond fabric (veil) previously described to combine the mat with the veil. In another embodiment, the 2.0 osy nylon spunbond fabric is replaced with a 1.0 osy nylon spunbond fabric previously described. The copolyamide web has a basis weight of about 0.6 osy, a softening point of about 105° C. and a melting point range of about 110° C. to about 120° C. The viscosity of the polymer that this web is made from is from about 51 cubic centimeters per 10 minutes to about 100 cubic centimeters per 10 minutes. The combined mat and veil can now be used as a single layer in a pultrusion process entering into a resin bath prior to entering into the die. In some embodiments, it may be preferable to prewet the veil and mat combination with resin prior to exposing it to the resin dip bath prior to the die.

In yet another embodiment, copolyamide adhesive netting can be used to combine the fiberglass mat to the veil. This copolyamide net can have a basis weight of about 0.9 osy, a softening point of about 105° C. and a melting point range of about 110° C. to 120° C. The melt viscosity of this copolyamide adhesive netting can range from about 19 cubic centimeters per 10 minutes to about 50 cubic centimeters per 10 minutes. This netting is commercially available from Protechnic in Cerney, France as Product 1G6. The combined mat and veil can now be used as a single layer in a pultrusion process entering into a resin bath prior to entering into the die. In some embodiments, it may be preferable to prewet the mat and veil combination with resin prior to exposing it to the resin dip bath prior to the die.

In another embodiment, an adhesive can be added to the sizing on reinforced fiber such as but not limited to aramid fibers, carbon fibers or glass fibers. In one embodiment, fiberglass can be in the form of a mat or roving. The fiberglass mat can then be combined with the veil and then used as a component saturated in resin to make a seamless fiberglass reinforced plastic part. In a specific embodiment, the mat with the sizing that includes adhesive can be combined just prior to entering a die in a pultrusion or similar process used to make fiberglass reinforced plastic parts by pressing the two layers, the fiberglass mat and the veil, together by using two press rolls. One or more of the press rolls can be heated to activate the adhesive if so necessary. In another similar embodiment, roving with sizing that contains adhesive can be used and fiberglass roving and veil can be combined by pressing the two layers together using press rolls prior to entering a die. One or more of the press rolls can be heated if necessary.

In all embodiments, it is crucial that the permeability of the composite be sufficient to allow the resin to flow through the veil and the reinforcement fibers so that the resin sufficiently “wets out” all the material. This will ensure that the part will be completely solidified and not defective after curing.

Different resin systems and fiber reinforced plastic processes can be used with this invention. One skilled in the art will realize that each combination of resin system and fiber reinforced plastic process will require optimization to achieve the results observed in the following examples. For example, different resins may require changes in processing temperatures, pressures, line speeds, reinforcing mat or roving, surfacing veils and/or adhesive systems. Different processes may require or allow the manufacturer to use different basis weights of mats or surfacing veils, different resins, different amounts of glass, etc. The practitioner must also select the surfacing veil with a permeability that will allow a sufficient flow of resin to wet out the reinforcement material. The combination of mass, thickness, permeability, tensile properties and adhesive system must be chosen correctly to achieve the desired results.

A greater understanding of the present invention and of its many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to the invention.

### Example 1

A 9 osy fiberglass mat was adhered to a 1 osy nylon spunbond fabric veil, Style 72100, available from Cerex Advanced Fabrics in Cantonment, Fla. to make a composite by using a 0.42 osy polyolefin adhesive web available from ProTechnic as product style 3B8D16. The nylon spunbond fabric is a 1 osy, thermally bonded fabric with a diamond pattern made with round filaments that contain TiO₂ and an optical brightener. Table 1 lists the typical properties of the individual items or layers used to make the composite. The adhesive web was placed between the fiberglass mat and the nylon spunbond veil and then heated using an iron for about 90 seconds at about 329° F. to combine the layers. Prior to adhering the layers together, thickness and air permeability were measured. These results are shown in Table 1 below. Table 1 below demonstrates that the composite made from the fiberglass and veil layers combined using the adhesive still has permeability. Indeed, comparing the permeability by placing the nylon spunbond veil on top of the fiberglass mat with no adhesive and then measuring air permeability of these two layers without combining them, shows that the permeability does not change much when the adhesive is added and melted between these two layers.

TABLE 1
Typical properties of fabric layers and adhesive web used to make
seamless fiber reinforced part using a 1 osy veil.

| | | Air | |
|---|---|---|---|
| | | permeability | Thickness |
| Item | Description | (ft³/min/ft²) | (in) |
| 72100 | 1 osy Nylon spunbond veil | 579 | 0.00877 |
| 9 Mat | 9 osy Fiberglass mat | 563 | 0.0468 |
| 3B8D16 | 0.42 osy Polyolefin adhesive | 1548 | 0.0060 |
| Adhered layers | 72100/3B8D16/9 Mat | 336 | 0.0510 |
| Layers without | 72100/9 Mat | 346 | 0.0522 |
| adhesive | | | |

### Example 2

A 9 osy fiberglass mat was adhered to a 2 osy nylon spunbond fabric veil, Style 72200, available from Cerex Advanced Fabrics in Cantonment, Fla. to make a composite by using a 0.42 osy polyolefin adhesive web available from ProTechnic as product style 3B8D16. The nylon spunbond fabric is a 2 osy, thermally bonded fabric with a diamond pattern made with round filaments that contain TiO₂ and an optical brightener. Table 2 lists the typical properties of the individual items or layers used to make the composite. The adhesive web was placed between the fiberglass mat and the nylon spunbond veil and then heated with an iron for about 90 seconds at about 365° F. to combine the layers. Prior to adhering the layers together, thickness and air permeability were measured. These results are shown in Table 2 below. Table 2 below demonstrates that the composite made from the fiberglass and veil layers combined using the adhesive still has permeability. Comparing the permeability by placing the nylon spunbond veil on top of the fiberglass mat with no adhesive and then measuring air permeability of these two layers without combining them shows that the permeability does not change much when the adhesive is added and melted between these two layers.

TABLE 2
Typical properties of fabric layers and adhesive web used to make
seamless fiber reinforced part using a 2 osy veil.

| | | Air | |
|---|---|---|---|
| | | permeability | Thickness |
| Item | Description | (ft³/min/ft²) | (in) |
| 72200 | 2 osy Nylon spunbond veil | 282 | 0.00125 |
| 9 Mat | 9 osy Fiberglass mat | 563 | 0.0468 |
| 3B8D16 | 0.42 osy Polyolefin adhesive | 1548 | 0.0060 |
| Adhered layers | 7220/3B8D16/9 Mat | 192 | 0.0600 |
| Layers without | 7220/9 Mat | 216 | 0.0606 |
| adhesive | | | |

### Example 3

A 9 osy fiberglass mat was adhered to a 1 osy nylon spunbond fabric veil, Style 72100, available from Cerex Advanced Fabrics in Cantonment, Fla. to make a composite by using a 0.6 osy copolyamide adhesive web available from ProTechnic as product style 3B8D16. The nylon spunbond fabric is a 1 osy, thermally bonded fabric with a diamond pattern made with round filaments that contain TiO₂ and an optical brightener. Table 3 lists the typical properties of the individual items or layers used to make the composite. The adhesive web was placed between the fiberglass mat and the nylon spunbond veil and then heated with an iron for about 90 seconds at about 365° F. to combine the layers. Prior to adhering the layers together, thickness and air permeability were measured. These results are shown in Table 3 below. Table 3 below demonstrates that the composite made from the fiberglass and veil layers combined using the adhesive still has permeability. Table 3 below demonstrates that the composite made from the fiberglass and veil layers combined using the adhesive still has permeability. Comparing the permeability by placing the nylon spunbond veil on top of the fiberglass mat with no adhesive and then measuring air permeability of these two layers without combining them shows that the permeability does not change much when the adhesive is added and melted between these two layers.

TABLE 3
Typical properties of fabric layers and adhesive web used to make
seamless fiber reinforced part using a 1 osy veil.

| | | Air | |
|---|---|---|---|
| | | permeability | Thickness |
| Item | Description | (ft³/min/ft²) | (in) |
| 72100 | 1 osy Nylon spunbond veil | 579 | 0.00877 |
| 9 Mat | 9 osy Fiberglass mat | 563 | 0.0468 |
| 1G8 | 0.6 osy Copolyamide adhesive | 792 | 0.00582 |
| Adhered layers | 72100/1G8/9 Mat | 325 | 0.05050 |
| Layers without | 72100/9 Mat | 346 | 0.0522 |
| adhesive | | | |

### Example 4

A 9 osy fiberglass mat was adhered to a 1 osy nylon spunbond fabric veil, Style 72100, available from Cerex Advanced Fabrics in Cantonment, Fla. to make a composite by using a proprietary adhesive. The nylon spunbond fabric is a 1 osy, thermally bonded fabric with a diamond pattern made with round filaments that contain TiO₂ and an optical brightener. Table 4 lists the typical properties of the individual items or layers used to make the composite. The adhesive web was placed between the fiberglass mat and the nylon spunbond veil and then heated in a lamination pilot line to combine the layers. Prior to adhering the layers together, thickness and air permeability were measured. These results are shown in Table 4 below. Table 4 below demonstrates that the composite made from the fiberglass and veil layers combined using the adhesive still has permeability. Table 4 below demonstrates that the composite made from the fiberglass and veil layers combined using the adhesive still has permeability. Comparing the permeability by placing the nylon spunbond veil on top of the fiberglass mat with no adhesive and then measuring air permeability of these two layers without combining them shows that the permeability changed about 50% when the two layers were combined indicated the importance of the proper selection of adhesive and amount of adhesive.

TABLE 4
Typical properties of fabric layers and adhesive web used to make
seamless fiber reinforced part using a 1 osy veil.

| | | Air | |
|---|---|---|---|
| | | permeability | Thickness |
| Item | Description | (ft³/min/ft²) | (in) |
| 72100 | 1 osy Nylon spunbond veil | 579 | 0.00877 |
| 9 Mat | 9 osy Fiberglass mat | 563 | 0.0468 |
| Adhered | 72100/proprietary adhesive/9 | 172 | 0.0499 |
| laminated | Mat | | |
| layers | | | |
| Layers without | 72100/9 Mat | 346 | 0.0522 |
| adhesive | | | |

### Example 5

A 9 osy fiberglass mat was adhered to a 2 osy nylon spunbond fabric veil, Style 72200, available from Cerex Advanced Fabrics in Cantonment, Fla. to make a composite by using a proprietary adhesive. The nylon spunbond fabric is a 2 osy, thermally bonded fabric with a diamond pattern made with round filaments that contain TiO₂ and an optical brightener. Table 5 lists the typical properties of the individual items or layers used to make the composite. The adhesive web was placed between the fiberglass mat and the nylon spunbond veil and then heated in a lamination pilot line to combine the layers. Prior to adhering the layers together, thickness and air permeability were measured. These results are shown in Table 5 below. Table 5 below demonstrates that the composite made from the fiberglass and veil layers combined using the adhesive still has permeability. Table 5 below demonstrates that the composite made from the fiberglass and veil layers combined using the adhesive still has permeability. Comparing the permeability by placing the nylon spunbond veil on top of the fiberglass mat with no adhesive and then measuring air permeability of these two layers without combining them shows that the permeability dropped about 31% when the two layers were combined indicated the importance of the proper selection of adhesive and amount of adhesive.

TABLE 5
Typical properties of fabric layers and proprietary adhesive web used to
make seamless fiber reinforced part using a 2 osy veil.

| | | Air | |
|---|---|---|---|
| | | permeability | Thickness |
| Item | Description | (ft³/min/ft²) | (in) |
| 72200 | 2 osy Nylon spunbond veil | 282 | 0.00125 |
| 9 Mat | 9 osy Fiberglass mat | 563 | 0.0468 |
| Adhered layers | 77200/proprietary adhesive/9 | 148 | 0.0556 |
| | Mat | | |
| Layers without | 7220/9 Mat | 216 | 0.0606 |
| adhesive | | | |

It should be understood that the examples and embodiments described herein are for illustrative purposes only and that various modifications or changes in light thereof will be suggested to persons skilled in the art and are to be included within the spirit and purview of this application and the scope of the appended claims.

All patents, patent applications, provisional applications, and publications referred to or cited herein (including those in the “References” section, if present) are incorporated by reference in their entirety, including all figures and tables, to the extent they are not inconsistent with the explicit teachings of this specification.

What is claimed is:

1. A seamless fiber reinforced plastic part, comprising:
a resin;
a veil;
reinforcement fiber; and
an adhesive,
wherein the reinforcement fiber and the veil are adhered together prior to being exposed to the resin used to make the part.

2. The fiber reinforced plastic part according to claim 1, wherein the reinforcement fiber is glass, aramid, carbon, or a combination thereof.

3. The fiber reinforced plastic part according to claim 1, wherein the reinforcement fiber is a mat or a roving fiber.

4. The fiber reinforced plastic part according to claim 1, wherein the adhesive is a web, a netting, a spunbond fabric, or a melt blown fabric.

5. The fiber reinforced plastic part according to claim 4, wherein the veil is a nylon spunbond fabric or a polyester spunbond fabric.

6. The fiber reinforced plastic part according to claim 1, wherein the adhesive is applied as a component of a sizing on the reinforcement fiber.

7. The fiber reinforced plastic part according to claim 1, wherein the adhesive is a polyvinyl acetate, ethylene vinyl acetate, polyamide, copolyamide, polyester, copolyester, polyolefin, acrylic, or a combination thereof.

8. A method of making a seamless reinforced fiber plastic part, the method comprising:
combining a reinforcement fiber and a veil with an adhesive to make a composite prior to exposing either the reinforcement fiber or the veil to a resin of the seamless reinforced fiber plastic part,
wherein the reinforcement fiber is a mat or a roving fiber.

9. The method according to claim 8, wherein press rolls are used to combine the veil and the reinforcing fiber.

10. The method according to claim 8, wherein a hot melt adhesive system is used to combine the veil and the reinforcing fiber prior to inserting both into a mold or die to make the seamless fiber reinforced plastic part.

11. The method according to claim 8, wherein the adhesive is applied to the veil.

12. The method according to claim 11, wherein the adhesive is printed on the veil.

13. The method according to claim 8, wherein the veil and the reinforcing fiber are combined using a lamination process.

14. The method according to claim 8, wherein the adhesive has a minimum melt point of 35° C.

15. The method according to claim 8, wherein the veil has a minimum basis weight of 0.2 ounces per square yard (osy) as measured by ASTM D3776.

16. The method according to claim 8, wherein the veil has an air permeability of more than 160 ft³/min/ft² as measured by ASTM D737.

17. The method according to claim 8, wherein the adhesive is applied at a level of 2 osy or less.

18. The method according to claim 8, wherein the adhesive is applied at a level of 0.01 osy or higher.
